(19) United States
(12) Patent Application Publication
(10) Pub. No.: US 2005/0061357 A1
(43) Pub. Date: Mar. 24, 2005

(54) Strippable PVA coatings and methods of making and using the same

(76) Inventors: John B. Steward, McKinney, TX (US); Jordan M. Johnston, Goodyear, AZ (US)

Correspondence Address: WITHERS & KEYS, LLC, P. O. BOX 2049, MCDONOUGH, GA, 30253, US

(21) Appl. No.: 10/947,580

(22) Filed: Sep. 22, 2004

Related U.S. Application Data
(60) Provisional application No. 60/505,179, filed on Sep. 23, 2003.

(51) Int. Cl. B08B 7/00; C11D 1/00

(52) U.S. Cl. 134/6; 510/511; 510/466

(57) ABSTRACT

Strippable polyvinyl alcohol (PVA) coatings and methods of making, using and disposing of strippable PVA coatings are disclosed.

### CROSS-REFERENCE TO RELATED APPLICATIONS

This patent application claims the benefit of priority to U.S. Provisional Patent Application Ser. No. 60/505,179 entitled “STRIPPABLE PVA COATINGS AND METHODS OF MAKING AND USING THE SAME” filed on Sep. 23, 2003, the subject matter of which is incorporated herein in its entirety.

### FIELD OF THE INVENTION

The present invention relates to strippable polyvinyl alcohol (PVA) coatings for use in industry. The present invention further relates to methods of making and using strippable polyvinyl alcohol (PVA) coatings.

### BACKGROUND OF THE INVENTION

There exists a need in the art for effective methods and products for detecting, handling, removing, and minimizing radioactive waste and contaminants in the nuclear industry.

### SUMMARY OF THE INVENTION

The present invention is directed to strippable polyvinyl alcohol (PVA) coatings.

The present invention is further directed to methods of making and using the strippable polyvinyl alcohol (PVA) coatings. In one exemplary method, the strippable polyvinyl alcohol (PVA) coatings are applied to a surface, removed from the surface after a desired period of time, and then disposed of by solubilizing the water-soluble material of the strippable polyvinyl alcohol (PVA) coatings.

The present invention is also directed to methods of removing one or more contaminants from an object, wherein the method comprises applying a strippable polyvinyl alcohol (PVA) coating onto the product, and removing the strippable polyvinyl alcohol (PVA) coating from the object after a desired period of time.

These and other features and advantages of the present invention will become apparent after a review of the following detailed description of the disclosed embodiments and the appended claims.

### DETAILED DESCRIPTION OF THE INVENTION

To promote an understanding of the principles of the present invention, descriptions of specific embodiments of the invention follow and specific language is used to describe the specific embodiments. It will nevertheless be understood that no limitation of the scope of the invention is intended by the use of specific language. Alterations, further modifications, and such further applications of the principles of the present invention discussed are contemplated as would normally occur to one ordinarily skilled in the art to which the invention pertains.

The present invention involves the use of a polyvinyl alcohol (PVA) matrix that is applied to surfaces as part of a decontamination system. The PVA coating serves to initially “fix” the contaminants in place for contaminant detection and ultimate removal. The PVA coating not only functions to mechanically entrap radioactive contaminants, but also contains one or more compounds that selectively entrap or bind certain radioactive isotopes or species to the PVA matrix. After use, the PVA coating containing one or more contaminants may be disposed of by dissolving the PVA coating and, if necessary, such as in the case of radioactive contaminants, separating the one or more contaminants from the dissolved PVA.

The PVA coatings of the present invention are described in detail below.

I. PVA Coating Composition

The PVA coatings of the present invention may comprise one or more of the following components:

A. PVA

The PVA coatings of the present invention contain at least one PVA. Suitable PVAs for use in the present invention desirably have the following properties: (1) water solubility in water having a water temperature of at least about 20° C., and (2) enables a coating made therefrom to remain stable at room temperature. The PVA may be designed to have a water solubility ranging from about 20° C. to about 90° C. For example, the PVA may be soluble in water having a water temperature of at least about 20° C., or at least about 37° C., or at least about 50° C., or at least about 75° C., or at least about 90° C.

The one or more PVAs may be present in an amount of up to about 50 wt % or higher based on a total weight of the PVA coating. Desirably, the one or more PVAs are present in an amount ranging from about 5.0 to about 50.0 wt % based on a total weight of the PVA coating. More desirably, the one or more PVAs are present in an amount ranging from about 5.0 to about 25.0 wt % based on a total weight of the PVA coating.

A number of commercially available PVAs may be used in the present invention. Suitable commercially available PVAs include, but are not limited to, PVAs commercially available under the trade designation EVANOL® from E. I. DuPont & Company (Wilmington, Del.). In one desired embodiment of the present invention, the PVA comprises EVANOL® 90-50 from E. I. DuPont & Company. In another desired embodiment of the present invention, the PVA comprises EVANOL® 71-30 from E.I. DuPont & Company.

B. Glycerol

The PVA coatings of the present invention desirably contain glycerol. Glycerol provides elasticity to the PVA coatings of the present invention.

The glycerol may be present in an amount of up to about 10.0 wt % based on a total weight of the PVA coating. Desirably, the glycerol is present in an amount ranging from about 2.0 to about 10.0 wt % based on a total weight of the PVA coating. More desirably, the glycerol is present in an amount ranging from about 4.0 to about 8.0 wt % based on a total weight of the PVA coating.

A number of commercially available glycerols may be used in the present invention. Suitable commercially available glycerols include, but are not limited to, glycerols commercially available from Lonza, Inc. (Fairlawn, N.J.) and Equistar (Dallas, Tex.).

C. Chelating/Complexing Agents

The PVA coatings of the present invention desirably contain one or more chelating and/or complexing agents. The chelating and/or complexing agents may be added to the PVA matrix of the PVA coating to target specific radioactive metals, such as to target Fe (iron), Mg (magnesium), Mn (manganese) and/or Co (cobalt). The added chelating and/or complexing agents may be added to the PVA coatings to enhance binding of the radioactive target metals. Modifications may be made to the chelating/complexing agents to make them more soluble, to bind them chemically to the PVA matrix, and/or to attach molecules with fluorescent labels.

A variety of chelating and/or complexing agents may be used in the present invention as described below.

1. Chelating Compounds/Polymers

The PVA coatings of the present invention may include one or more chelating agents. Such chelating agents are particularly useful to target the removal of radioactive cobalt. Suitable chelating agents include, but are not limited to, ethylenediamine-tetraacetic acid (EDTA); a chelating copolymer having a hydrophobic backbone and hydrophilic side groups attached thereto, wherein the hydrophilic side groups comprise essentially half of an EDTA molecule such as in the exemplary formula as shown below: 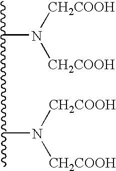
wherein [symbol] represents the copolymer chain; or a mixture thereof. Suitable chelating copolymers include, but are not limited to, copolymers having a polymer chain formed from styrene and divinylbenzene monomers.

The above-described copolymers have a high selectivity of transition metal ions like Co⁺² and Co⁺³ even in high salt concentrations.

In one desired embodiment of the present invention, the PVA coatings include EDTA alone or in combination with one or more additional chelating and/or complexing agents described herein. When present, EDTA is desirably present in the PVA coatings of the present invention in an amount of up to about 5 wt % based on a total weight of the PVA coating. More desirably, the EDTA is present in an amount ranging from greater than 0 to about 1.0 wt % based on a total weight of the PVA coating.

2. Arene or Crown Ether Compounds

The PVA coatings of the present invention may also include one or more arene and/or crown compounds. Arene and/or crown compounds have high selectivity for extraction of cesium (Cs) from contaminated surfaces. Suitable arene and/or crown compounds include, but not limited to, calix-4-arene and 18-crown-6 ether shown below.

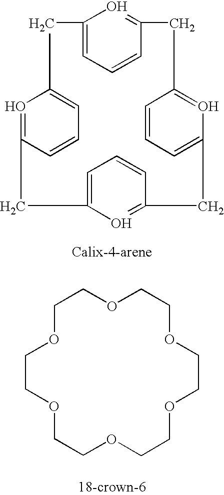

In one desired embodiment of the present invention, the above-referenced complexing agents are present in the PVA coating at a ratio of two 18-crown-6 molecules per molecule of calix-4-arene. Suitable initial concentrations of the complexing agents may be 0.007 M of calix-4-arene and 0.014 M 18-crown-6.

Since the PVA emulsions of the present invention have a high water content, it is believed that the Cs on a contaminated surface of an object migrates into the PVA and is bound by the calix-4-arene and/or 18-crown-6 compounds.

Water solubility of the calix-4-arene may be improved by the addition of sulfonated groups on the aryl rings as disclosed in the methods of Mathieu et al. (See, Mathieu et al., Water-soluble para-sulfonated 1,2,3,4-calix-4-arene bis crowns in the cone configuration, Tetrahedron Letters (2002), 43, 1225-1229.)

When any of the above-described chelating/complexing agents are present in the PVA coatings of the present invention, each chelating/complexing agent is desirably independently present in the PVA coatings in an amount of up to about 5 wt % based on a total weight of the PVA coating. More desirably, each chelating and/or complexing agent is independently present in an amount ranging from greater than 0 to about 1.0 wt % based on a total weight of the PVA coating.

D. Surfactants

The PVA coatings of the present invention may comprise one or more surfactants. Suitable surfactants for use in the present invention provide one or more of the following features: (1) acts as a dispersant to evenly disperse PVA polymers, metal particles, chelating/complexing agents (when present), other components, or a combination thereof; (2) acts to increase the efficiency of the coating in removing contaminants; (3) acts to improve the shelf life of unused PVA coating solutions; and (4) acts to reduce the surface tension of the coating composition. Suitable surfactants for use in the present invention include, but are not limited to, sodium polynaphthalene sulfonate surfactants, polyether modified polydimethyl-siloxane surfactants, nonionic ethoxylated alcohols having from about 6 to about 10 ethylene oxide units per molecule, and combinations thereof. Desirably, the PVA coatings of the present invention comprise one or more nonionic surfactants including, but are not limited to, nonionic ethoxylated alcohols having from about 6 to about 10 ethylene oxide units per molecule.

The one or more surfactants may be present in the PVA coatings of the present invention an amount of up to about 5.0 wt % based on a total weight of the PVA coating. Desirably, the one or more surfactants are each independently present in an amount ranging from about greater than 0 to about 1.0 wt % based on a total weight of the PVA coating.

A number of commercially available surfactants may be used in the present invention. Suitable commercially available surfactants include, but are not limited to, sodium polynaphthalene sulfonate surfactants available under the trade designation REACT-RITE® Dispersant #1; polyether modified polydimethyl-siloxane surfactants available from BYK-Chemie USA Inc. (Wallingford, Conn.) under the trade designation BYK-348; and nonionic ethoxylated alcohol surfactants sold under the trade designation TRITON™, available from Union Carbide Corporation (South Charleston, W. Va.), such as TRITON™ X100 (t-octylphenoxypolyethoxyethanol) (a nonionic ethoxylated alcohols having 9.5 ethylene oxide units per molecule).

In one desired embodiment of the present invention, the PVA coating comprises REACT-RITE® Dispersant #1 in an amount of greater than 0 to about 1.0 wt % based on a total weight of the PVA coating, and BYK-348 in an amount of greater than 0 to about 1.0 wt % based on a total weight of the PVA coating.

E. Solvent Systems

The PVA coatings of the present invention comprise water as a primary solvent or carrier, but may also include other solvents in combination with water as described below.

1. Water

Soft or hard water may be used in the present invention, although soft water is more desirable. As used herein, the term “soft water” refers to water containing less than about 60 ppm of calcium carbonate. As used herein, the term “hard water” refers to water containing more than about 60 ppm of calcium carbonate, while “very hard water” refers to water containing more than about 180 ppm of calcium carbonate. The PVA coatings of the present invention may be formed using water available from any source, including any municipal water-treatment facility.

The PVA coatings of the present invention typically comprise up to about 90 weight-percent (wt %) of water based on a total weight of the PVA coating. Desirably, the PVA coatings of the present invention comprise from about 30 to about 85 wt % water based on a total weight of the PVA coating. More desirably, the PVA coatings of the present invention comprise from about 50 to about 80 wt % water based on a total weight of the PVA coating.

2. Ethanol

Ethanol may also be used in combination with water to form a suitable solvent system for the PVA coatings of the present invention. Desirably, the ethanol is denatured ethanol. The ethanol assists in the curing rate and evaporation rate of the applied PVA coating, improving the curing time and speed of the entire decontamination process.

When present, the ethanol may be present in the PVA coatings of the present invention an amount of up to about 25.0 wt % based on a total weight of the PVA coating. Desirably, the ethanol is present in an amount ranging from about greater than 0 to about 15.0 wt % based on a total weight of the PVA coating.

F. Additives

The PVA coatings of the present invention may further comprise one or more of the following additives.

1. Colorants

The PVA coatings of the present invention may also comprise one or more colorants to assist in the identification of applied PVA coatings on various surfaces. Further, in some embodiments, the colorants may exhibit a color change, which indicates the presence of radioactive material within the PVA coating. In one embodiment, a yellow, red or orange colorant is added to a PVA coating.

The one or more colorants may be present in the PVA coatings of the present invention an amount of up to about 6.0 wt % based on a total weight of the PVA coating. Desirably, the one or more colorants are present in an amount ranging from about greater than 0 to about 5.0 wt % based on a total weight of the PVA coating.

2. pH Control Agents

The PVA coatings of the present invention may also comprise one or more components to adjust/control the pH of the PVA coating. Desirably, the PVA coating has a pH in the range of from about 1 to about 12, more desirably, from about 3 to about 10. Typically, when present, the one or more pH control agents are present in an amount of up to about 10 wt % based on a total weight of the PVA coating in order to obtain a desired pH for the PVA coatings.

Suitable pH control agents include, but are not limited to, inorganic acidic compounds including sodium hydrogen sulfate, calcium phosphate and hydrogen phosphate; organic acid compounds including carboxylic acids such as oxalic acid, and polyacrylic acid; inorganic alkaline compounds including hydroxides, silicates, and carbonates; and organic alkaline compounds including amines and alkoxides.

3. Fiber Reinforcements

The PVA coatings of the present invention may further comprise water-soluble fibers, such as PVA fibers. Suitable PVA fibers and methods of making PVA fibers are disclosed in U.S. Pat. Nos. 5,181,967; 5,207,837; 5,268,222; 5,620,786; 5,885,907; and 5,891,812; the disclosures of all of which are hereby incorporated in their entirety by reference. An example of a suitable polyvinyl alcohol fiber for use in the present invention is a polyvinyl alcohol homopolymer that has been highly crystallized by post-drawing or by heat annealing.

The water-soluble fibers may be present in the PVA coatings of the present invention as individual fibers, such as chopped PVA fibers, having an average fiber length of less than about 2.54 cm (1 inch).

When present, the water-soluble fibers may be present in the PVA coatings of the present invention an amount of up to about 25.0 wt % based on a total weight of the PVA coating. Desirably, the water-soluble fibers, when present, are present in an amount ranging from about greater than 0 to about 15.0 wt % based on a total weight of the PVA coating.

4. Biocides

The PVA coatings of the present invention may also comprise one or more biocides to prevent the growth of organisms in the PVA coating materials and/or the PVA coating. The one or more biocides may be present in the PVA coatings of the present invention an amount of up to about 5.0 wt % based on a total weight of the PVA coating. Desirably, the one or more biocides are present in an amount ranging from about greater than 0 to about 1.0 wt % based on a total weight of the PVA coating.

Suitable biocides for use in the present invention include, but are not limited to, triclosan and other antimicrobial agents commercially available under the trade designation MICROBAN®; and antimicrobial agents sold under the trade designation DOWICIL™, available from Dow Chemical Company (Midland, Mich.), such as DOWICIL™ 75 (active ingredient: 1-(3-chloroallyl)-3,5,7-triaza-1-azoniaadamantane chloride).

II. Methods of making The PVA Coating Compositions

The PVA coatings of the present invention may be prepared using conventional mixing techniques. The components for forming the PVA coatings may be combined with water in any order at room temperature. Typically, PVA coatings are prepared by combining the components in the following order while mixing: water, one or more additional solvents (when present), one or more surfactants (when present), PVA, glycerol, one or more chelating/complexing agents (when present), one or more pH control agents (when present), and one or more additives (when present).

III. Methods of Using The PVA Coating Compositions

The strippable PVA coatings of the present invention have significant advantages over traditional coatings. The strippable PVA coatings of the present invention may possess additional components to improve decontamination effectiveness via chemical bonding with subject contamination. The PVA-based coating offers distinct advantages, most notably the ability to volume-reduce efficiently the subsequent waste created during a decontamination operation. PVA formulations may be made readily solubilizable, oxidizable and break down to a relatively benign form following use. The present invention offers a unique “cradle-to-grave” approach that provides significant waste management benefits.

The strippable PVA coatings may be used in both the commercial and government nuclear industries. Strippable coatings of the present invention have a number of advantages over other popular decontamination methods. A strippable PVA coating can be applied to a surface quickly, thus “fixing” the contaminants in place and mitigating further spread and additional contact or uptake by personnel. Depending on contamination levels and associated dose rates involved, access and/or work in the area may continue at a substantially reduced exposure risk once the contaminants are fixed to the surfaces involved. The strippable PVA coatings can subsequently be removed or “stripped” from the surfaces, removing the contaminants with the coating. The contaminated coatings are then packaged and transported, if necessary, for final disposition. There are no liquid waste streams associated with the use of these coatings thus eliminating the burden of managing large volumes of liquid radioactive wastes that sometimes accompany other popular decontamination methods.

The stripped PVA coatings latent with captured radionuclides desirably do not contain species listed by RCRA, CWA and SARA (e.g. EPA's List of List) and other environmental regulations and thereby complicate its subsequent disposition.

The PVA coatings of the present invention may be applied to a variety of substrates, such as rough substrates (e.g. concrete) and smooth substrates (e.g. marble). Such substrates have wide variations in composition and bonding affinities for potential contaminants. The PVA coatings may be applied using any conventional application including, but not limited to, brushing, spraying, etc.

In one desired embodiment of the present invention, the PVA coating is used to remove one or more radioactive contaminants from a surface. The method of removing one or more radioactive contaminants from a surface of an object may comprise the steps of (1) applying a strippable film to the surface of the object, wherein the strippable film comprises polyvinyl alcohol (PVA), water, and at least one surfactant; and (2) removing the strippable film from the surface of the object.

IV Methods of Disposing of Stripped PVA Coatings

The present invention is further directed to methods of disposing of the stripped PVA coatings. The method of disposing of the stripped PVA coatings is desirably one of the methods disclosed in U.S. Pat. No. 6,623,643, filed on Sep. 23, 2003; International Publication No. WO 01/36338 corresponding to PCT Application No. PCT/US00/26553; and PCT Application No. PCT/US02/16184, filed on May 22, 2002; the disclosures of all of which are hereby incorporated in their entirety by reference. In these methods of disposal, the method may include one or more of the following steps:
(1) placing the stripped PVA coating into a disposal reactor;
(2) introducing water into the reactor to form a solution;
(3) optionally introducing a pH adjusting agent, such as an acid (e.g., acetic acid) or a base (e.g., sodium hydroxide), to the solution;
(4) adding a degradation-enhancing reactant or a precursor of a degradation-enhancing reactant to the solution;
(5) heating the aqueous solution so as to react the precursor to form the degradation-enhancing reactant, if necessary, and reacting with the water-soluble polymer of the stripped PVA coating to form one or more degradation products;
(6) optionally, filtering non-solubilized material from the aqueous environment;
(7) optionally, measuring a parameter indicator of the concentration of polymer material in the aqueous environment;
(8) optionally, filtering material, e.g., radioactive material, from the aqueous environment;
(9) optionally, altering, e.g., neutralizing, the pH of the aqueous environment;
(10) optionally, biodegrading the resulting degradation products in the aqueous environment, e.g., organic acids form CO₂, H₂O and biomass; and
(11) removing any insoluble components from the reactor.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto.

1. A strippable film composition comprising polyvinyl alcohol (PVA), water and at least one surfactant.

2. The strippable film composition of claim 1, wherein the at least one surfactant comprises a sodium polynaphthalene sulfonate surfactant, a polyether modified polydimethyl-siloxane surfactant, a nonionic ethoxylated alcohol surfactant having from about 6 to about 10 ethylene oxide units per molecule, or a combination thereof.

3. The strippable film composition of claim 2, wherein the composition comprises greater than 0 up to about 5.0 wt % of a nonionic ethoxylated alcohol surfactant having from about 6 to about 10 ethylene oxide units per molecule, based on a total weight of the strippable film composition.

4. The strippable film composition of claim 1, further comprising glycerol in an amount of greater than 0 up to about 10.0 wt %, based on a total weight of the strippable film composition.

5. The strippable film composition of claim 1, further comprising ethanol in an amount of greater than 0 up to about 15.0 wt %, based on a total weight of the strippable film composition.

6. The strippable film composition of claim 1, further comprising at least one chelating agent in an amount of greater than 0 up to about 1.0 wt %, based on a total weight of the strippable film composition.

7. The strippable film composition of claim 6, wherein the at least one chelating agent comprises ethylenediamine-tetraacetic acid (EDTA).

8. The strippable film composition of claim 1, further comprising at least one colorant in an amount of greater than 0 up to about 5.0 wt %, based on a total weight of the strippable film composition.

9. The strippable film composition of claim 1, further comprising at least one biocide in an amount of greater than 0 up to about 5.0 wt %, based on a total weight of the strippable film composition.

10. The strippable film composition of claim 9, wherein the at least one biocide comprises 1-(3-chloroallyl)-3,5,7-triaza-1-azoniaadamantane chloride.

11. The strippable film composition of claim 1, wherein the composition comprises:
from about 50 to about 90 wt % water;
from about 5.0 to about 20.0 wt % PVA;
up to about 5.0 wt % of a nonionic ethoxylated alcohol surfactant having from about 6 to about 10 ethylene oxide units per molecule;
from about 4.0 to about 10.0 wt % glycerol;
up to about 1.0 wt % EDTA;
up to about 5.0 wt % of at least one colorant; and
up to about 5.0 wt % of at least one biocide;
wherein all weight percentages are based on a total weight of the strippable film composition.

12. The strippable film composition of claim 1, wherein the composition comprises:
from about 50 to about 90 wt % water;
from about 5.0 to about 20.0 wt % PVA;
up to about 5.0 wt % of a nonionic ethoxylated alcohol surfactant having about 9.5 ethylene oxide units per molecule;
from about 4.0 to about 10.0 wt % glycerol;
up to about 1.0 wt % EDTA;
up to about 5.0 wt % of at least one colorant; and
up to about 5.0 wt % of at least one biocide comprising 1-(3-chloroallyl)-3,5,7-triaza-1-azoniaadamantane chloride;
wherein all weight percentages are based on a total weight of the strippable film composition.

13. The strippable film composition of claim 1, wherein the composition comprises:
from about 50 to about 90 wt % water;
from about 5.0 to about 20.0 wt % PVA;
from greater than 0 up to about 5.0 wt % of sodium polynaphthalene sulfonate, polyether modified polydimethyl-siloxane, a nonionic ethoxylated alcohol surfactant having from about 6 to about 10 ethylene oxide units per molecule, or a combination thereof;
from about 4.0 to about 10.0 wt % glycerol;
from greater than 0 up to about 1.0 wt % EDTA;
from greater than 0 up to about 5.0 wt % of at least one colorant; and
from greater than 0 up to about 5.0 wt % of at least one biocide;
wherein all weight percentages are based on a total weight of the strippable film composition.

14. The strippable film composition of claim 1, further comprising at least one chelating or complexing agent selected from EDTA; a chelating copolymer having a hydrophobic backbone and hydrophilic side groups attached thereto, wherein the hydrophilic side groups comprise half of an EDTA molecule; crown ethers; calix-4-arene; and combinations thereof.

15. The strippable film composition of claim 14, wherein the strippable film composition comprises 18-crown-6 ether.

16. The strippable film composition of claim 14, wherein the strippable film composition comprises 18-crown-6 ether and calix-4-arene.

17. The strippable film composition of claim 14, wherein the strippable film composition comprises a calix-4-arene having one or more sulfonate groups on one or more aryl rings of the calix-4-arene.

18. The strippable film composition of claim 14, wherein the strippable film composition comprises a chelating copolymer of styrene and divinylbenzene.

19. A method of removing radioactive contaminants from a surface of an object, said method comprising the steps of:
applying a strippable film composition to the surface of the object, wherein the strippable film composition comprises polyvinyl alcohol (PVA), water and at least one surfactant; and
removing the strippable film composition from the surface of the object.

20. The method of claim 19, wherein the at least one surfactant comprises a sodium polynaphthalene sulfonate surfactant, a polyether modified polydimethyl-siloxane surfactant, a nonionic ethoxylated alcohol surfactant having from about 6 to about 10 ethylene oxide units per molecule, or a combination thereof.

21. The method of claim 20, wherein the composition comprises greater than 0 up to about 5.0 wt % of a nonionic ethoxylated alcohol surfactant having from about 6 to about 10 ethylene oxide units per molecule, based on a total weight of the strippable film composition.

22. The method of claim 19, wherein the composition further comprises at least one biocide in an amount of greater than 0 up to about 5.0 wt %, based on a total weight of the strippable film composition.

23. The method of claim 22, wherein the at least one biocide comprises 1-(3-chloroallyl)-3,5,7-triaza-1-azoniaadamantane chloride.

24. The method of claim 19, wherein the composition comprises:
from about 50 to about 90 wt % water;
from about 5.0 to about 20.0 wt % PVA;
up to about 5.0 wt % of a nonionic ethoxylated alcohol surfactant having from about 6 to about 10 ethylene oxide units per molecule;
from about 4.0 to about 10.0 wt % glycerol;
up to about 1.0 wt % EDTA;
up to about 5.0 wt % of at least one colorant; and
up to about 5.0 wt % of at least one biocide;
wherein all weight percentages are based on a total weight of the strippable film composition.

25. The method of claim 19, wherein the composition comprises:
from about 50 to about 90 wt % water;
from about 5.0 to about 20.0 wt % PVA;
from greater than 0 up to about 5.0 wt % of sodium polynaphthalene sulfonate, polyether modified polydimethyl-siloxane, a nonionic ethoxylated alcohol surfactant having from about 6 to about 10 ethylene oxide units per molecule, or a combination thereof;
from about 4.0 to about 10.0 wt % glycerol;
from greater than 0 up to about 1.0 wt % EDTA;
from greater than 0 up to about 5.0 wt % of at least one colorant; and
from greater than 0 up to about 5.0 wt % of at least one biocide;
wherein all weight percentages are based on a total weight of the strippable film composition.

26. The method of claim 19, wherein the applying step comprises spraying the strippable film composition onto the surface of the object.

27. The method of claim 19, wherein the applying step comprises brushing the strippable film composition onto the surface of the object.

28. The method of claim 19, further comprising:
placing the strippable film composition into a disposal reactor;
introducing water into the reactor to form an aqueous solution;
heating the aqueous solution to dissolve or degrade the PVA of the strippable film composition; and
separating at least a portion of the radioactive contaminants from the PVA and the aqueous solution.

29. A strippable film composition consisting essentially of:
a single polymer, wherein the single polymer is polyvinyl alcohol (PVA);
water;
glycerol;
EDTA;
a nonionic ethoxylated alcohol surfactant having about 9.5 ethylene oxide units per molecule;
a biocide comprising 1-(3-chloroallyl)-3,5,7-triaza-1-azoniaadamantane chloride; and
at least one colorant.
